(19) United States
(12) Patent Application Publication
(10) Pub. No.: US 2002/0032627 A1
(43) Pub. Date: Mar. 14, 2002

(54) System and method for managing and tracking customer incentive securities

(76) Inventors: Henry Ross Perot, Dallas, TX (US); Steven L. Blasnik, Dallas, TX (US)

Correspondence Address: William N. Hulsey III, Hughes & Luce, L.L.P., Suite 2800, 1717 Main Street, Dallas, TX, 75201, US

(21) Appl. No.: 09/834,035

(22) Filed: Apr. 11, 2001

Related U.S. Application Data
(60) Provisional application No. 60/196,452, filed on Apr. 11, 2000.

(51) Int. Cl. G06F 17/60

(52) U.S. Cl. 705/35

(57) ABSTRACT

The current invention relates to a system that manages consumer incentive securitys. The system allows a security to have a predetermined associated risk. The system has a server that monitors economic activity of an individual related to a retailer, producer, or manufacturer. When an individual performs an economic transaction, the server correlates that transaction with their history. Based on that history, the individual is offered discounts or other actions related to the entity's securities. Transactions are tracked using networking technology, and may be involve online ordering, or wireless enabled ordering. Additionally, the individual may purchase a first security. The server tracks the individual's transactions, and offers to convert portions of the first security for a second security upon predetermined criteria. The issuer can use a portion of the initial investment to guarantee a predetermined risk. Thus, the investor enjoys a predefined risk, and has the option to participate in the upside of the second security when he or she converts it.

### RELATED APPLICATIONS

This application claims priority of U.S. Patent Application, Ser. No. 60/196,452, filed Apr. 11, 2000 entitled: “CUSTOMER INCENTIVE CONVERTIBLE SECURITIES”, and is incorporated herein by reference in its entirety.

### BACKGROUND

1. Field of the Invention

The present invention generally relates to a system for tracking and managing securities. More particularly, this invention relates to a system for tracking and managing securities that have a consumer activity component associated with their management. More particularly, it relates to a method and system that enables a security with a predefined risk element to be issued.

2. Description of Prior Art

Many typical examples of securities include common and preferred stock, or warrants. For common stock, a consumer purchases a security that may fluctuate, at times quite wildly. In return, the owner of the common stock has a right to vote on stockholder issues, and may receive a dividend from the corporation issuing the stock.

In the terms of a preferred stock, the issued stock typically has no voting rights associated with it. However, the owner of the stock typically receives preferential rights as to dividends. Again, the value of the security is subject to fluctuations.

Warrants typically are quoted option certificates issued by companies. They entitle the holder to buy a specific number of shares in that company at a specific price (the exercise price), at a specific time or times, during a specific period in the future, or after a specific event. They can be freely transferable, freely marketed on an exchange, or restricted in nature. As such they are rather like long-term call options, presenting opportunities for capital gain which can make them an attractive medium for both speculative and longer-term investing.

The difference from options is that, when exercised, the shares come from the company and not from another investor. When sold in a free market, they again suffer the same drawback in that their value may widely fluctuate.

An entity may issue bonds, but these have a long-term drain on the issuing entity for their interest. The consumer has alleviated risk, but the onus is then placed on the entity to manage the money and paybacks. All of these instruments suffer from the ability of a consumer to translate their spending habits into ownership of an instrument or other form of ownership, such as a unit in a partnership. The consumer cannot translate their network-based purchases into ownership interest, nor can owners use their consumer status to convert existing ownership interests into more preferable forms of ownership, based upon the circumstances.

Further, the typical household in the United States has gained an increased fascination with the stock market in recent years. More and more people observe, participate, and hold securities. However, their ability to “play the market” and participate on an active, daily basis is not great, since most individuals do not invest in the market as a full time vocation. In this manner, most people are restricted to the level of participation in the stock market to persons who buy and sell securities on a time-to-time basis.

As such, many securities and their associated tracking and management systems suffer from risks associated with their volatility. Many other problems and disadvantages of the prior art will become apparent to one skilled in the art after comparing such prior art with the present invention as described herein.

### SUMMARY OF THE INVENTION

Aspects of the invention are found in a networked transaction tracking system that relates consumer activity to ownership in an entity. The tracking system allows a consumer's activities to be translated into ownership interests in an entity. In one aspect, a consumer's network based activities are reported to a central server, wherein the server offers the consumer the ability to participate in ownership of the entity. The activity is Internet purchases from predefined locations, purchases from remote locations such as vending machines or store outlets, wireless based purchases based on cell phone authorizations or digital assistant authorizations, or purchases using smart card technologies.

When sufficient activity has occurred, the central server determines the ownership actions. In one case, it allows the consumer to convert one type of ownership to another. Or, it may offer the consumer rebates or discounts from stock from the entity itself.

In another aspect, the conversion aspect allows an entity to define a security with a predefined risk. Thus, the consumer knows precisely what the downside may be in an investment scenario. The predefined risk may be zero over a set length of time, and as such the only cost to the consumer is the time value of the investment. Economic activities allow the consumer to convert the first predefined risk security into another security intended to provide greater opportunity for gain.

Other aspects, advantages and novel features of the present invention will become apparent from the detailed description of the invention when considered in conjunction with the accompanying drawings.

### BRIEF DESCRIPTION OF THE DRAWINGS

FIG. 1 is a block diagram of a securities management system in according to the invention.

FIG. 2 is a flow diagram detailing some aspects of the operation of an exemplary aspect of the invention.

FIG. 3 is a flow diagram of another embodiment of the operation of the invention of FIG. 1.

FIG. 4 is another flow diagram detailing an exemplary embodiment an operation of the system of FIG. 3, wherein the risk associated with the first issued instrument or unit may be limited.

### DETAILED DESCRIPTION

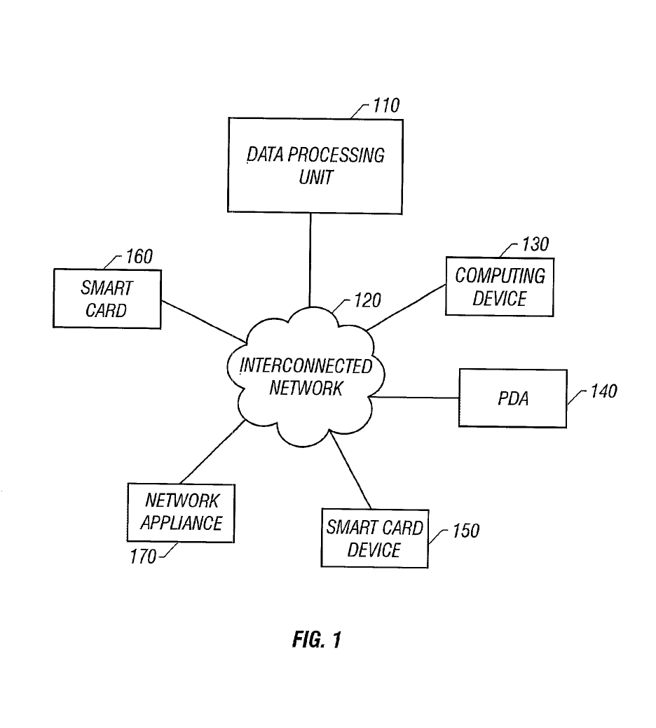

FIG. 1 is a block diagram of a defined-risk securities system in an exemplary aspect of the invention, according to the invention. A data processing server 110 is communicatively coupled to an interconnected network 120. The interconnected network is typified by the commonly known Internet, but may be a secure network, a virtual private network, an intranet, or other means by which multiple computing devices may interact at a distance.

The data processing server 110 is coupled to the interconnected network 120 through one of many types of connections, including a telephone based modem connection, digital subscriber line, T1 or T3 line, cable line, optical connection, or wireless connection. In this manner, the server 110 may communicate with a number of other computing devices, such as the computing device 130, the personal digital assistant (PDA) 140, the remote smart-card enabled device 150, a link with a smart card 160, or any of the like.

The server 110 preferably includes a way for entering financial data, such as the keyboard 112. The server 110 also contains a financial database 114. The financial database operates to store certain financial and/or securities data, explained elsewhere in this document. This data includes an identifier for consumers, whereby the activities of the consumer can be reached.

In another embodiment, the activity need not take place through a computing device. In another example, a consumer uses a so-called “smart card” to transact business at a remote location. The information on the purchase may be gleaned from the electronic data generated at the point of sale, such as a checkout line at a supermarket. The information on the purchase can be aggregated either in the smart card or through a network linked checkout register. The information on the economic activity is transmitted to the server 110, where the appropriate securities related determinations are made.

In one example, the transaction is stored on the smart card 160 at the point of sale device. Later, the holder of the smart card enables communication with the networked server 110, wherein the appropriate economic activity may be monitored and stored.

Another process where the storage and determination of security related activity may be made through a wireless or wired network appliance, such as a network appliance 170. A user performs economic activity through the network appliance 170. The network appliance 170 then transmits the information pertaining to the transaction to the server 110 through the interconnected network 120. The network appliance 170 may be a vending machine, a slot machine, an entertainment device, or any electronically linked apparatus that performs economic activity. This activity may include either goods or services.

The network appliance 170 may be linked to a user in a variety of ways. A keypad may be used, or the user may access the functionality of the network appliance through a wireless connection. The wireless connection may be wireless network connection, such as that defined by the Bluetooth technology specification that details a roving TCP/IP connection for mobile devices, or may be through the use of cellular phone technology.

It should be noted that the network appliance may contain local storage, and that the network appliance may transmit the economic activity information on an intermittent basis. Or, the economic activity could be transmitted by another associated device, such as a network linked handheld device that downloads the economic activity to another network-linked device, and eventually to the server 110. In this manner, an entity can attract and retain customers. This is perhaps, the greatest challenge facing many consumer businesses. Such a system that offers customers ownership interests in the business on attractive terms could help to attract and retain those customers. This system allows those ownership interests would become more valuable as the customer-owner's patronage grows. This system provides an attractive and efficient system for attracting and retaining customers using ownership securities. Each of the ancillary clients, meaning the computing device 130, the PDA 140, the smart card enabled device 150, the network appliance 170, or the smart card 160, all have a transactional component that facilitates an economic transaction. This may be in the form of hardware and software. In one embodiment, the various circuitries run downloaded software code to facilitate the transaction. Or this may be accomplished through a web browsing software.

Each client also has a transactional relay component. This could be a direct network connection, or a mass storage unit to store the transaction date for later transmittal to the server 110. In each transaction, an identifier is used to distinguish the particular individual with the transaction.

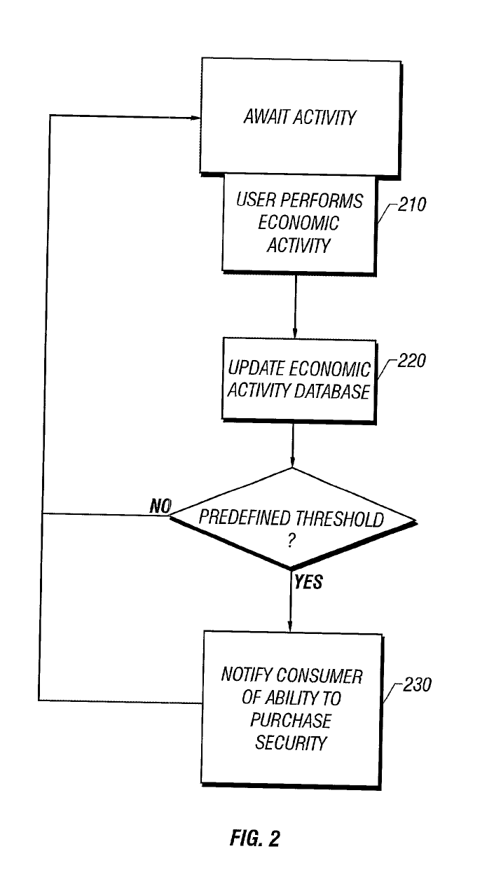

FIG. 2 is a flow diagram detailing operational characteristics of an exemplary server of FIG. 1. First, consumer performs some retail or purchasing function in an online fashion in a block 210. This could include such actions as ordering goods and services over the Internet. The system could be operated on behalf of a retailer, distributor, or provider of goods or services. Purely by way of example, the following description refers to the issuer of the securities utilizing the system as a retailer. Upon the ordering of the goods and/or services, the retailer modifies a database in an associated computing device with financial information relating to that consumer in a block 220. In one aspect of the invention, after a predefined threshold of some sort has been met, the retailer notifies the consumer that such transaction or aggregation of transactions have enabled the consumer to purchase an amount of securities in the retailer entity. This occurs in a block 230.

The notification may come after some predefined threshold, or automatically. In one instance, the retailer notes each and every transaction associated with the particular consumer. After the consumer has spent a predefined amount of money, a predefined amount of securities are made available to the consumer. The price for such a security may be varied. In one instance, the security is given to the consumer at no charge. In one embodiment, the retailer may make the security available to the consumer at a discounted rate. Or, the rate at which the security is made available to the consumer may be dependent upon the economic activity with the retailer. In this case, the more economic activity with the retailer through the electronic medium, the better the discount on the sale of securities.

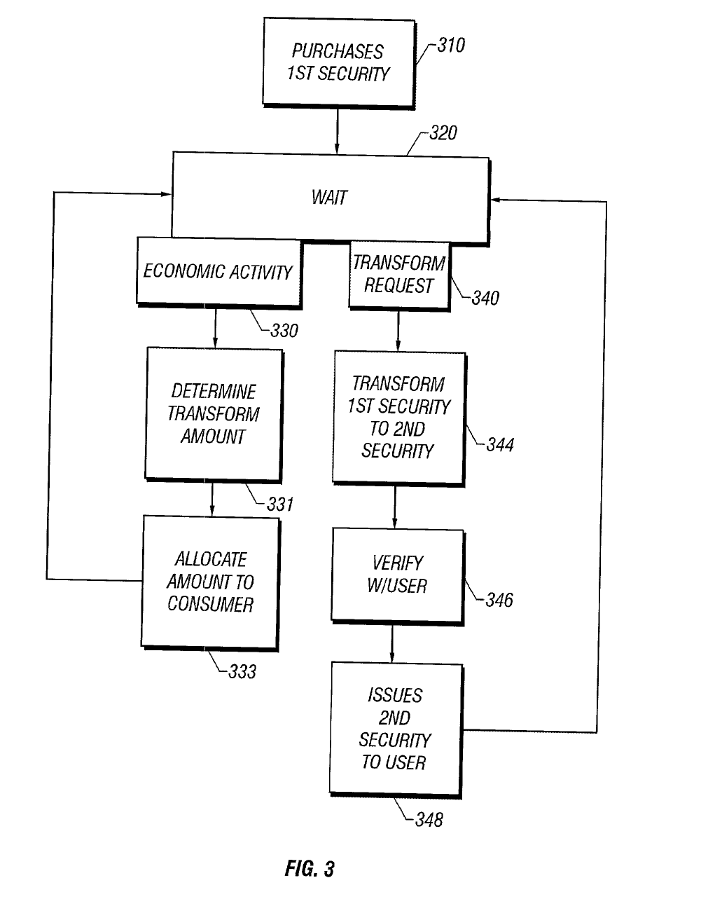

FIG. 3 is a flow diagram of another embodiment of the operation of the invention of FIG. 1. In this case, the consumer purchases a preferred stock in a step 310. The purchase of the preferred stock is recorded in the data storage mechanisms describe above in relation to the server 110. The preferred stock has the characteristics of non-voting, and may or may not be freely traded on an open market. In one embodiment, the preferred stock is restricted and may not be freely traded.

In a block 320, the system awaits an indication of economic activity. This economic activity may be those as described above in relation to FIG. 1. In a block 330, a holder of the preferred stock has performed some economic activity that is to be rewarded by the operator of the server 110. Control then flows to a block 331, where the system performs a security transaction determination. The determination may be any of those listed in relation to FIG. 1. Or, the activity may be an activity that allows the holder of the preferred stock to convert the preferred stock to shares of freely traded common stock. The determination of how much preferred stock may be converted is determined upon the specific transaction type, and/or on the transaction amount.

This amount is allocated to the consumer in the block 333. Upon the completion of the economic activity, the consumer then has the ability to transform a predetermined amount of the first instrument to a second instrument at some price.

An additional price for the second instrument, if any, may be determined at this stage, or may be determined when such conversion is exercised. Additionally, bonuses may be granted to the consumer for additional conversion rights based upon the level of activity or the type of activity. This bonus may be reflected either in an enhanced conversion rate, or in a discounted price.

In one embodiment, the conversion right from the first instrument to the second instrument has no associated price with it. In this case, the economic activity simply allows the consumer/instrument holder the right to transform a certain number of shares or units of the first issued instrument into a certain number of shares of the second issued instrument.

In a block 340, the server 110 has received an indication form the consumer indicating that the consumer/shareholder wishes to transform a portion first issued shares or units into the second type of shares or units. The server 110 may send out a confirmation of the requested action, or otherwise verify the identity and propriety of the action. This may take place through a Public Key Infrastructure (PKI) system, wherein a digital certificate and conformation is required to perform the action. Or, any other number of digital confirmations may take place.

In another embodiment, the consumer/shareholder manually requests that the conversion take place. In this case, the system operator would either enter this information by hand, or cause it to be entered via some electronic scanning and logging process. In this case, a digital image of the manual order may be saved and associated with the economic activity, thus to verify and confirm that the transformation is proper. In a block 344, the system transforms the first issued shares or units to another type of shares or units. In a block 346, the system verifies the transformation process with an acknowledgement of the transaction to the consumer. This acknowledgement may be digital in nature, such as an email, or the acknowledgement may be printed out to send to the consumer via manual delivery methods.

In a block 348, the system the issues the second type shares or units to the consumer. In this manner, the consumer may obtain or transform a security through economic activity.

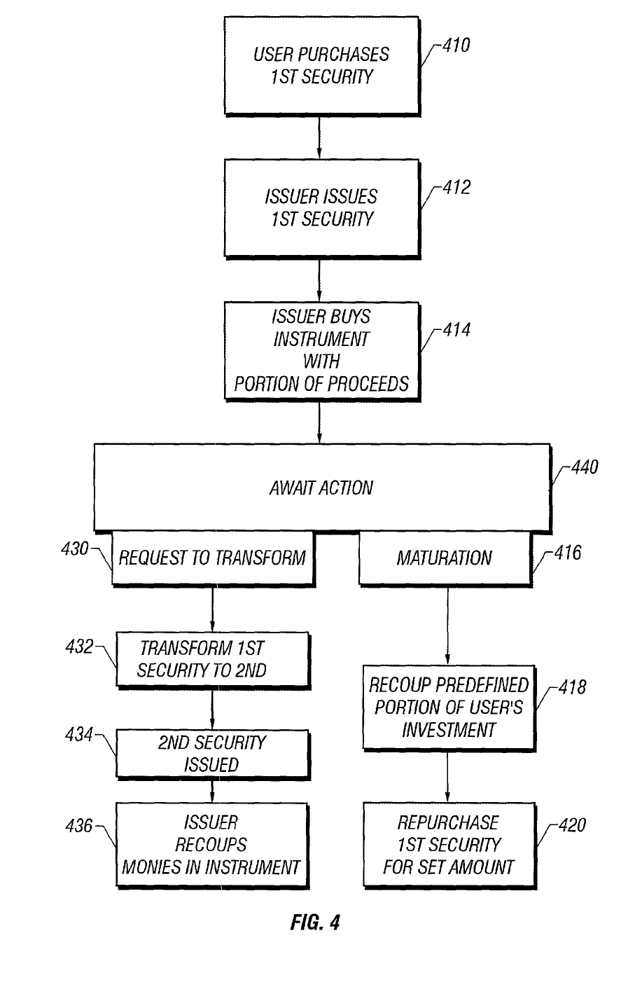

FIG. 4 is another flow diagram detailing an embodiment of the invention of FIG. 3, wherein the risk associated with the first issued instrument or unit may be limited. In a block 410, the consumer purchases the first security type and submits payment. In one embodiment, the shares are limited to subscribed members. In a block 412, the issuer entity sends the purchased first security or unit to the consumer.

In a block 414, the issuer of the instrument or unit purchases another instrument with a portion of the proceeds from the purchase price of the instrument or unit. In one example, the issuing entity buys highly rated bonds, such as AAA rated bonds, which mature at some predetermined point in the future. In another example, the issuing entity transfers a portion of the proceeds to a creditworthy third party that guarantees the return of principal to the consumer. Thus, the issuer can limit the risk to the consumer with the purchase of these bonds, and use the remaining funds for operational purposes.

In terms of the invention, the block 416 indicates an interim waiting period. In a block 416, assume that time for maturation of the bonds has passed. In this case, control flows to a block 418, wherein the issuer receives an amount of money equal to the original purchase from the bond seller. Thus, the instrument issuing entity can limit the risk to the consumer for the first instrument to the time growth and opportunity cost of the original investment. At a block 420, the instrument issuing entity may repurchase the remaining preferred shares from the original consumer. As such, the consumer has not lost any principal on his investment.

It should be noted that using other types of instruments such as annuities might be used in this process as well. Further, instead of defining riskless investment, the instrument issuing entity may limit the risk to a preset downside, based upon the operating costs that they wish to use and to the profit/risk preferences of the consumer.

In one embodiment of the invention, a consumer wishing to maintain a high rate of conversion based on economic activity may actually prefer a higher degree of risk offset to the higher return. In this case, the consumer may agree to a slight degree of actual loss on the initial investment in return for a higher conversion rate for the second instrument. This new conversion rate may be affected through any of the parameters that go into the final conversion schedules.

In another embodiment, the instrument issuing entity may increase the required predetermined criteria necessary to convert on a basis. This may include increasing the necessary criteria on an annual basis, or some other temporal basis.

In a block 430, the consumer exercises a portion of the conversions that they have earned. In this case, control flows to a block 432 where the appropriate first shares or units are transformed into the second class of shares or units. These second shares or units are relayed to the consumer in a block 434.

In this case, since the need no longer exists to have security for the first issued shares or units due to the transformation, the issuing entity may “cash out” of its position that limits the risk to the consumer. This is indicated in the block 436. In this manner, the issuing entity may then use the cash collected for the converted first shares or units for operational purposes. The defined system has many advantages. They include:

1. For customers:

(a) Get to participate in the upside of the stock of the business;

(b) Defined downside risk due to right to get a determined portion of principal back;

(c) Creates additional use for “loyalty points” and similar customer reward benefits, with the possibility of much larger value.

(d) If the consumer converts to common stock and sells at profit, the profit would be taxed at favorable capital gains rate.

2. For the issuer:

(a) Can use the interest value of the customer capital for general business purposes;

(b) Gives customers additional incentives to patronize the business;

(c) Generate positive financial feedback: the more customers do, the more valuable the common stock becomes, the greater the incentive for customers to further increase activity to qualify for conversion, etc.

Example of a Specific Instance of the Invention

Convertible Preferred Stock issued by XYZ Corporation:

1. Distribution: Registered Preferred Shares offered continuously, but only to Members. Each Member may purchase up to $1000.00 of Shares.

2. Price: Initially will be offered at $10.00 per share. Price increases periodically to reflect the growth in Membership, as determined by the Board of Directors. Once the Common Stock is publicly traded, the Preferred Shares will be issued at the Common trading price.

3. Redemption: The Holder or the Company may, at their option, redeem Preferred Shares at their original issue price any time after the second anniversary of the purchase date. The Company's right to call Shares for redemption is subject to the Member's contingent right to convert the shares as described below.

4. Conversion right: The Member may convert all (but not part) of his Preferred shares into common stock (one-for-one) at any time when he has earned sufficient points on the XYZ.com web site. Points are earned by executing web-based transactions, e.g., buying products from affiliated web sites. The number of points required increases based on a schedule (e.g. 20,000 points required initially, increasing 10,000 points on each anniversary of issuance).

5. Preference: The preferred has a liquidation preference over the common.

6. No voting rights: Preferred has no voting rights.

7. Dividends: The preferred shares receive the same dividends as the Common stock (none expected). 8.

Trading: The Preferred Shares are transferable, but only the Member who originally purchased the Shares may convert them. Due to this restriction, it is unlikely that a liquid market for Preferred shares would develop.

9. Credit rating: The Preferred would be rated AAA by Standard and Poor's or equivalent, as a result of AAA-rated financial institution guarantee of the mandatory redemption.

10. Income to company: The company transfers a portion of the proceeds to an account to fund the redemption. The remaining proceeds are used for general corporate purposes.

11. Use of principal amount: As preferred shareholders convert to common, extinguishing the redemption right, the principal amount becomes available to the company to be used for general corporate purposes.

Illustrative Implementation

The XYZ.com web site provides for electronic enrollment of Members. In addition, XYZ.com preferably has links to third party content sites at which Members purchase products and/or services to earn points. Alternatively, e-commerce can originate from the site itself, or may be associated with other network-transacted business, such as that described in relation to FIG. 1.

Thus, the present invention may be implemented within a web-based transaction environment such as the Internet. As described above, a client machine may use an application, such as a web browser, to access a server via a computer network. A network typically includes other servers (not shown) for control of domain name resolution, routing and other control functions. A representative server is a computer or workstation having at least one processor, system memory (e.g., RAM), disk or other permanent storage, I/O devices, an operating system, a server program, and an application programming interface (API) that provides extensions to enable application developers to extend and/or customize the core functionality thereof through software programs including plug-ins, CGI programs, Java servlets, and the like. One such software program is a mechanism that enables the providing of the information service of this invention. In an illustrative embodiment, the mechanism is implemented on native code in Java executable in a processor. The inventive functionality, of course, may be part of the integral web server program.

A representative server machine is an IBM Neffinity platform running the Unix or Linux operating system and a server program such as IBM WebSphere Version 2.0 or Apache. Of course, any other computer hardware or software may be used.

A representative client is a personal computer, notebook computer, Internet appliance or pervasive computing device (e.g., a PDA or palm computer) that is Pentium-, PowerPC®- or RISC-based. The client includes an operating system such as Microsoft Windows, Microsoft Windows CE or PalmOS. A typical client includes a suite of Internet tools including a Web browser, such as Netscape Navigator or Microsoft Internet Explorer, that has a Java Virtual Machine (JVM) and support for application plug-ins or helper applications. Communications between the client and the server typically conform to the Hypertext Transfer Protocol (Version 1.0 or higher), and such communications may be made over a secure connection.

As such, a system for managing and tracking securities ownership of a consumer is described. Additionally, a system for managing a defined risk marketable security is described. In view of the above detailed description of the present invention and associated drawings, other modifications and variations will now become apparent to those skilled in the art. It should also be apparent that such other modifications and variations might be effected without departing from the spirit and scope of the present invention as set forth in the claims that follow.

We claim:

1. A client for determining entitlement of ownership of stocks in a company, the client system comprising:
an identifier that identifies a customer relative to an ownership position in the company;
a transactional component that facilitates an economic transaction;
a transactional relay component, communicatively coupled to the transactional component, that facilitates a response to a server system regarding the economic transaction, the response including the identifier so that the server system can locate additional information on the customer and so that the server system can associate information on the economic transaction to the customer.

2. The client of claim 1 wherein the client communicates to the server through an interconnected network.

3. The client of claim 1 wherein the transactional relay component is a mass storage device.

4. The client of claim 1 wherein the economic transaction is a transaction taking place through an interconnected network.

5. The client of claim 1 wherein the transactional component is a web browser.

6. The client of claim 1 wherein the transactional component is circuitry facilitating a transaction.

7. The client of claim 1 wherein the transactional relay component is a wireless network interface.

8. The client of claim 1 wherein the identifier is received from another source.

9. The client of claim 8, the other source comprising a personal digital assistant.

10. The client of claim 8, the other source comprising a wireless networking device.

11. The client of claim 8, the other source comprising a wireless device.

12. The client of claim 8, the other source comprising digital smart card.

13. A server system for determining entitlement of ownership in a company, the server system comprising:
a transactional reception component that receives information on an economic transaction relating to an individual;
a transactional processing component, communicatively coupled to the transactional reception component, that determines in what form the individual may participate in ownership of the company;
a data storage medium, communicatively coupled to the transactional processing component, that stores information on ownership rights in the company relating to the individual;
the transactional processing component determining that the individual is entitled to convert a first form of ownership in the company to a second form of ownership; and
the risk associated with the first form of ownership being limited to a predetermined amount, the predetermined amount being less than an initial investment of the individual in the first form of ownership.

14. The system of claim 13, wherein the transactional reception component is an interface to an interconnected network.

15. The system of claim 14 wherein the transactional reception component is a mass storage device reader.

16. The system of claim 13 wherein the transactional reception component is a keyboard.

17. The system of claim 13 wherein the conversion from the first form to the second form is based on a predetermined criteria

18. The system of claim 17 wherein the predetermined criteria is a level of economic activity.

19. The system of claim 13 wherein the data storage medium is a semiconductor memory.

20. The system of claim 13 wherein the first form of ownership is a preferred stock.

21. The system of claim 13 wherein the second form of ownership is a common stock.

22. The system of claim 13 wherein the predetermined amount is zero.

23. The system of claim 13 wherein the predetermined amount is less than 20 percent of the initial investment.

24. A server system for determining entitlement of ownership in a company, the server system comprising:
a transactional reception component that receives information on an economic transaction relating to an individual;
a transactional processing component, communicatively coupled to the transactional reception component, that determines whether the individual may participate in ownership of the company;
a data storage medium, communicatively coupled to the transactional processing component, that stores information on ownership rights in the company relating to the individual; and
the transactional processing component determining that the individual is entitled to convert a first form of ownership in the company to a second form of ownership based upon predetermined criteria.

25. The system of claim 24, wherein the transactional reception component is an interface to an interconnected network.

26. The system of claim 24 wherein the transactional reception component is a mass storage device reader.

27. The system of claim 24 wherein the transactional reception component is a keyboard.

28. The system of claim 24 wherein the conversion from the first form to the second form is based on a predetermined criteria.

29. The system of claim 28 wherein the predetermined criteria is a level of economic activity.

30. The system of claim 24 wherein the data storage medium is a semiconductor memory.

31. The system of claim 24 wherein the first form of ownership is a preferred stock.

32. The system of claim 24 wherein the second form of ownership is a common stock.

33. A method for determining an ownership interest in an entity for an individual, the entity having a first and a second types of ownership interest, the individual holding the first type of ownership representing an amount of investment, the method comprising:
monitoring economic activity associated with the individual;
offering an individual an opportunity to convert the individual's first type of ownership in the entity to the second type of ownership interest based upon predefined criteria; and
limiting the risk associated with the first type of ownership to an amount less than the investment.

34. The method of claim 33, the step of monitoring taking place through an interconnected network.

35. The method of claim 33, the claim of monitoring occurring over a web browser.

36. The method of claim 33 wherein the economic activity is effectuated by a wireless device.

37. The method of claim 33 wherein the economic activity is effectuated by a network appliance.

38. The method of claim 33 wherein the first ownership interest is preferred stock.

39. The method of claim 33 wherein the second ownership interest is common stock.

40. The method of claim 33 wherein the predetermined criteria is a level of economic activity.

41. The method of claim 33 wherein the first ownership interest has an expiration time.

42. The method of claim 33, the step of limiting the risk comprising investing a portion a proceeds from the investment into a fixed income investment.

43. The method of claim 33, the step of limiting the risk comprising investing a portion a proceeds from the investment into a bond.

44. The method of claim 33, the step of limiting the risk comprising securing a financial guarantee from a third party.

45. The method of claim 33, the step of limiting the risk comprising investing a portion of the amount of investment with a guarantor.

46. The method of claim 33, wherein the amount less than the investment is zero.

47. The method of claim 33, wherein the amount less than the investment is less than 20% of the investment amount.
